(19) United States
(12) Patent Application Publication
(10) Pub. No.: US 2015/0066327 A1
(43) Pub. Date: Mar. 5, 2015

(54) ECO-MODE CRUISE CONTROL

(71) Applicant: FORD GLOBAL TECHNOLOGIES, LLC, Dearborn, MI (US)

(72) Inventors: Fazal Urrahman Syed, Canton, MI (US); Matthew Allen Warner, Saline, MI (US); Ryan J. Skaff, Farmington Hills, MI (US); Benjamin Carl Mukkala, Ann Arbor, MI (US); Terry Gene Feldpausch, Carleton, MI (US); Ming Lang Kuang, Canton, MI (US); David H. Schmitt, Livonia, MI (US); Elaine Y. Chen, Dearborn, MI (US)

(73) Assignee: FORD GLOBAL TECHNOLOGIES, LLC, Dearborn, MI (US)

(21) Appl. No.: 14/015,033

(22) Filed: Aug. 30, 2013

(51) Int. Cl. B60W 30/14

(52) U.S. Cl. CPC B60W 30/143
USPC 701/93

(57) ABSTRACT

A vehicle cruise control system includes an ECO-cruise mode such that a rate of acceleration of the vehicle during cruise control is less than or equal to a maximum that is a function of vehicle speed and road grade. Further, the rate is a function of the vehicle speed and a difference between the vehicle and target cruise control speeds.

### TECHNICAL FIELD

This disclosure relates to vehicle cruise control operation and the management of fuel consumption during cruise control operation.

### BACKGROUND

Conventional cruise control systems are designed to maintain vehicle speed by controlling the vehicle accelerator. This results in an acceleration request when the speed drops below a predetermined hysteresis level and a deceleration request when the speed increases above a predetermined hysteresis level. Along with the deceleration request, the vehicle's brakes may be applied to reduce the vehicle speed to the vehicle set speed. When traveling up a steep incline, the acceleration request may be such that it is equivalent to wide open throttle.

### SUMMARY

A vehicle cruise control system includes at least one controller programmed to, in response to a decrease in vehicle speed relative to a target cruise speed in an absence of driver acceleration demands, cause the vehicle to accelerate at a rate. The rate is less than or equal to a maximum that depends on road grade and the vehicle speed, and depends on the vehicle speed and a difference between the vehicle and target cruise speeds.

A method of controlling vehicle speed includes receiving a target cruise control speed and a cruise control operating mode, selecting a speed control gain based on the cruise control operating mode and a difference between vehicle speed and the target cruise control speed, and generating a weighted speed error from the difference based on the speed control gain. The method further includes generating a road gradient compensation ratio based on the cruise control operating mode and a road gradient force representing a road grade, and accelerating the vehicle at a rate based on the road gradient compensation ratio, the weighted speed error, and the vehicle speed such that the rate increases as the vehicle speed increases when the road grade is generally constant in an absence of driver acceleration demands and the rate decreases as the road grade increases in the absence of driver acceleration demands.

A method for controlling vehicle speed includes, in response to a decrease in vehicle speed relative to a target cruise control speed in an absence of driver acceleration demands, causing the vehicle to accelerate at a rate. The rate is less than or equal to a maximum that depends on vehicle speed and road grade, and depends on the vehicle speed and a difference between the vehicle and target cruise control speeds such that the rate increases as the vehicle speed increases when the road grade is generally constant and the rate decreases as the road grade increases.

### BRIEF DESCRIPTION OF THE DRAWINGS

FIG. 1 illustrates an example hybrid electric vehicle with cruise control functionality;

FIG. 2 illustrates a flow diagram of driver evaluator and driver assist blocks of a vehicle cruise control algorithm;

FIG. 3 illustrates a flow diagram of an ECO-cruise control algorithm.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

An engine or motor is a machine designed to convert energy into useful mechanical motion. The engine or motor can be an internal combustion engine, an electric motor or other electric machine. The efficiency at which this conversion is performed is based on criteria such as the beginning rotational speed, the desired rotational speed, and how quickly to accelerate from the current speed to the desired speed.

Certain vehicles equipped with cruise control functionality use general algorithms and calibration schemes when cruise control is activated. One common algorithm is a simple PID control loop which is enabled when the vehicle speed crosses a threshold point. The result of this control method is that the throttle may reach a fully open position. This may result in sub-optimal fuel economy as the current control system tries to achieve a desired cruise control performance.

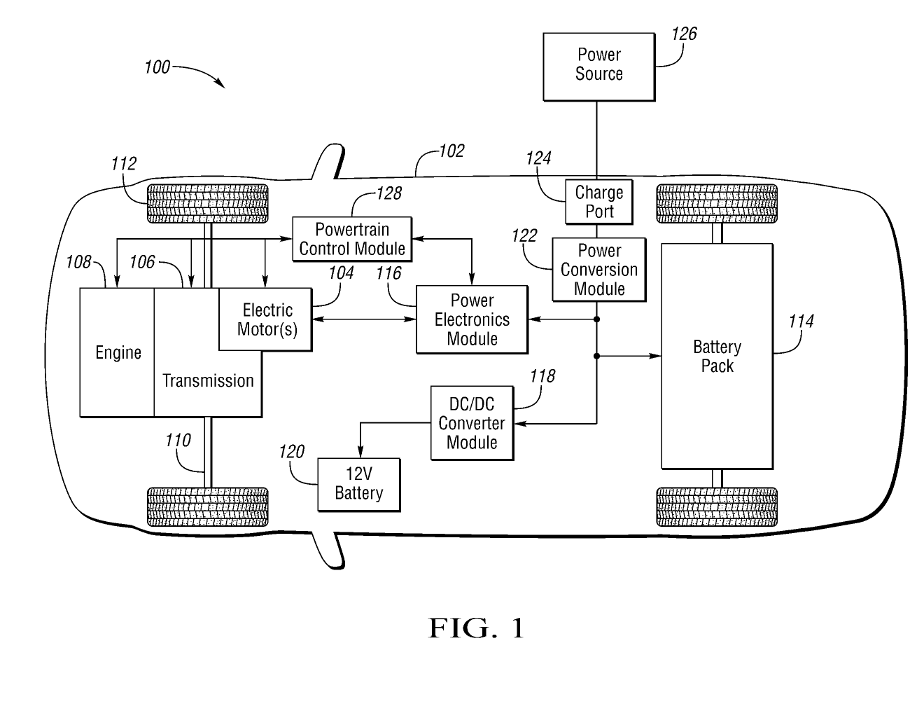

FIG. 1 depicts an example of a plug-in hybrid-electric vehicle. A plug-in hybrid-electric vehicle 102 may comprise one or more electric motors 104 mechanically connected to a hybrid transmission 106. In addition, hybrid transmission 106 is mechanically connected to an engine 108. The hybrid transmission 106 may also be mechanically connected to a drive shaft 110 that is mechanically connected to wheels 112. The electric motors 104 can provide propulsion when the engine 108 is turned on. The electric motors 104 can provide deceleration capability when the engine 108 is turned off The electric motors 104 may be configured as generators and can provide fuel economy benefits by recovering energy that would normally be lost as heat in the friction braking system. The electric motors 104 may also reduce pollutant emissions since the hybrid electric vehicle 102 may be operated in electric mode under certain conditions.

Battery pack 114 stores energy that can be used by the electric motors 104. The vehicle battery pack 114 typically provides a high voltage DC output. The battery pack 114 is electrically connected to a power electronics module 116. The power electronics module 116 is also electrically connected to the electric motors 104 and provides the ability to bi-directionally transfer energy between the battery pack 114 and the electric motors 104. For example, a typical battery pack 14 may provide a DC voltage while the electric motors 4 may require three-phase AC current to function. The power electronics module 16 may convert the DC voltage to three-phase AC current as required by the electric motors 104. In a regenerative mode, the power electronics module 116 will convert the three-phase AC current from the electric motors 104 acting as generators to the DC voltage required by the battery pack 114. The methods described herein are equally applicable to a pure electric vehicle or any other device using a battery pack.

In addition to providing energy for propulsion, the battery pack 114 may provide energy for other vehicle electrical systems. A typical system may include a DC/DC converter module 118 that converts the high voltage DC output of the battery pack 114 to a low voltage DC supply that is compatible with other vehicle loads. Other high voltage loads, such as compressors and electric heaters, may be connected directly to the high-voltage bus from the battery pack 114. In a typical vehicle, the low voltage systems are electrically connected to a 12V battery 120. An all-electric vehicle may have a similar architecture but without the engine 108.

The battery pack 114 may be recharged by an external power source 126. The external power source 126 may provide AC or DC power to the vehicle 102 by electrically connecting through a charge port 124. The charge port 124 may be any type of port configured to transfer power from the external power source 126 to the vehicle 102. The charge port 124 may be electrically connected to a power conversion module 122. The power conversion module may condition the power from the external power source 126 to provide the proper voltage and current levels to the battery pack 114. In some applications, the external power source 126 may be configured to provide the proper voltage and current levels to the battery pack 114 and the power conversion module 122 may not be necessary. The functions of the power conversion module 122 may reside in the external power source 126 in some applications.

The vehicle engine, transmission, electric motors and power electronics may be controlled by a powertrain control module (PCM) 128. The vehicle cruise control function can reside in almost any electronic module including the PCM 128. The vehicle cruise control function may also reside in a module separate from the PCM 128, including but not limited to a body control module (BCM), an instrument panel cluster (IPC), a steering column control module (SCCM), an infotainment module, a navigation module, etc.

In addition to illustrating a plug-in hybrid vehicle, FIG. 1 can illustrate a battery electric vehicle (BEV) if components 108, 122, 124 and 126 are removed. Likewise, FIG. 1 can illustrate a traditional hybrid electric vehicle (HEV) or a power-split hybrid electric vehicle if components 122, 124 and 126 are removed.

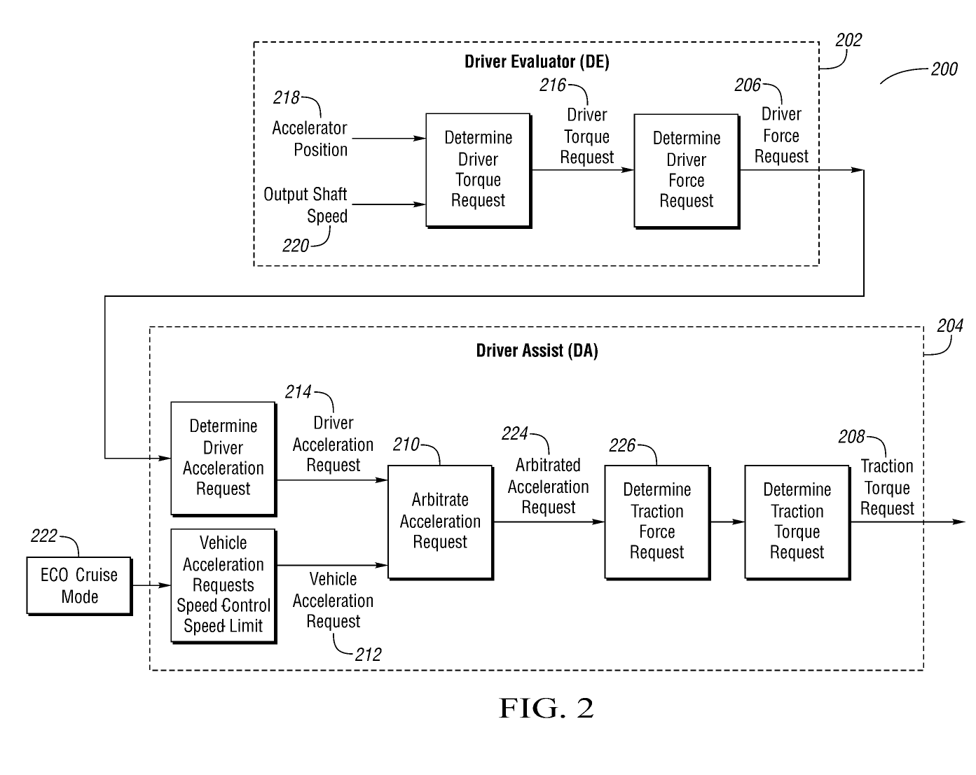

FIG. 2 illustrates an example of an ECO-cruise control flow diagram 200. This ECO-cruise control function 200 can be implemented in the Powertrain Control Module 128 or other module which controls or modifies the speed control. This ECO-cruise control example flow diagram 200 includes a Driver Evaluator (DE) 202 and a Driver Assist (DA) function block.

The Driver Evaluator (DE) 202 is a function block that generates requests such as driver force request 206. Driver Assist (DA) 204 is a functional block that generates requests such as traction torque request 208. The DA 204 arbitrates a driver acceleration request 210 with other vehicle acceleration requests 212, such as speed control and speed limiting, and generates traction torque request 214.

In the DE 202, the system determines a driver torque request 216 based on input such as pedal position 218, output shaft speed 220, vehicle speed, engine speed or an equivalent, etc. The driver torque request 216 is converted to the driver force request 206. In the DA 204, the system converts the driver force request 206 to a driver acceleration request 214. The system 200 also determines other vehicle acceleration requests 212 from various inputs including vehicle speed control, a speed cruise control function, a vehicle speed limiting function, adaptive speed control function, etc. The ECO-cruise functionality may be implemented in the vehicle speed control function which determines the vehicle acceleration request 212 for the speed control using ECO-cruise Mode 222. An arbitrated acceleration request 224 is determined by arbitrating the driver acceleration request 214 with these other vehicle acceleration requests 212. The system converts the arbitrated acceleration request 224 to a traction force request 226 and then determines the final traction torque request 208.

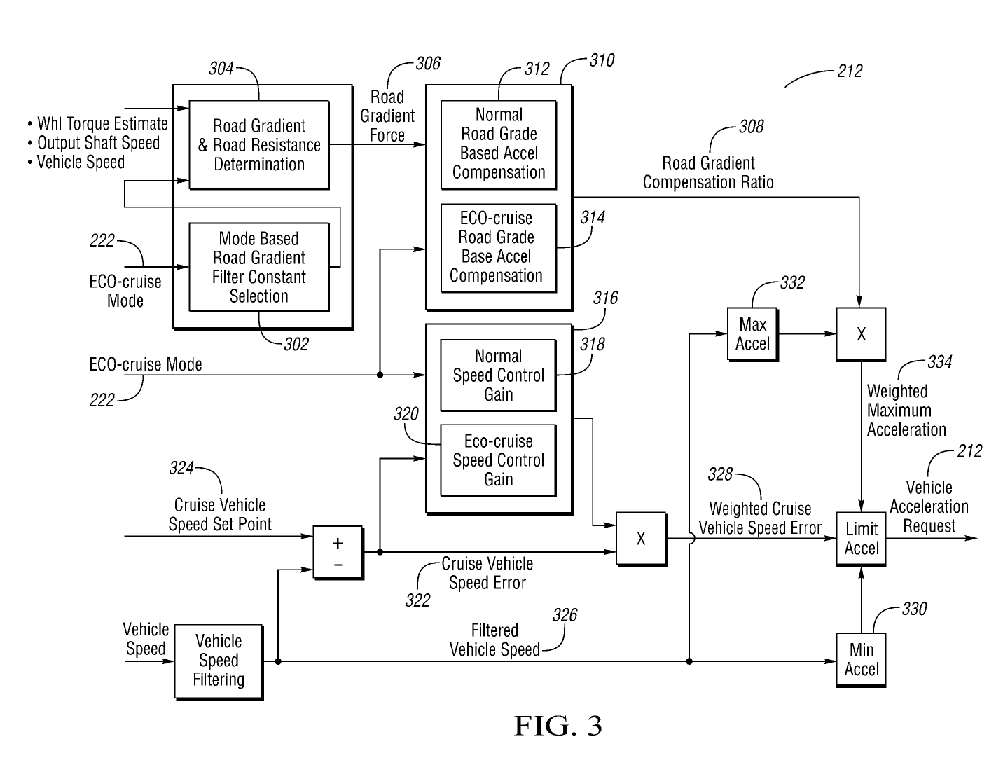

FIG. 3. illustrates a flow diagram for determining the vehicle acceleration request 212. The ECO-Cruise Mode 222 may be selected by the driver or the selection may be performed automatically by another module, or a preference setting. The ECO-Cruise Mode 222 is an input that may be implemented many ways including a physical button, a soft button in a human machine interface (HMI), a graphical user interface (GUI), or automatically in an electronic module such as powertrain control module (PCM) 128, a navigation module, an electronic stability control module or the like. With the ECO-Cruise Mode 222, the control system 200, when determining the vehicle acceleration request 212 in the vehicle speed control function, can use specific fuel economy tailored algorithms and calibrations to improve vehicle real world fuel economy.

The ECO-Cruise Mode 222 input selects mode based road gradient filter constants 302. The filter constants or filter coefficients 302 along with other inputs including wheel torque, output shaft speed, vehicle speed, acceleration, inclination (from a sensor such as a G-sensor), and other data are received by road gradient and road resistance determination block 304. The road gradient and road resistance determination block 304 generates a road gradient force 306, which may be calculated real-time or prior to operation and stored as a look-up table. The road gradient force 306 along with the ECO-Cruise Mode 222 is used to determine a road gradient compensation ratio 308 by selectively using a road grade based acceleration compensation matrix 310. The road grade based acceleration compensation matrix 310 is a function of the road gradient force 306, vehicle speed, and the ECO-Cruise Mode 222. This vector calculation allows the road grade based acceleration compensation ratio 308 to adapt to operating parameters input via the road gradient force 306. For example, if the vehicle speed increases, the road grade based acceleration compensation ratio 308 may also increase to compensate for the increase in force needed to accelerate the vehicle due to the increased air resistance. If the road grade increases, the Road Gradient Force will increase and the algorithm may decrease the road grade based acceleration compensation ratio 308. Alternatively, if the road grade increases, the road grade based acceleration compensation ratio 308 may increase to overcome the additional force due to the elevation change. This can be implemented to include a normal road grade based acceleration compensation vector matrix 312 and an ECO-cruise road grade based acceleration compensation vector matrix 314, but also may have other matrices for alternative modes including a sport mode, a highway mode, and a city mode.

The ECO-Cruise Mode 222 is also an input to a speed control gain matrix 316. This can be implemented to include a normal speed control gain 318 and an ECO-cruise speed control gain 320 but also may have other matrices for alternative modes including a sport mode, a highway mode, and a city mode. The speed control gain matrix 316 is shown with the input to the matrices being cruise vehicle speed error 322 and ECO-Cruise Mode 222. The cruise vehicle speed error 322 is calculated by comparing the cruise vehicle speed set point 324 and a filtered vehicle speed 326. The cruise vehicle speed error 322 is adjusted by the speed control gain constant derived from the speed control gain block 316 to determine a weighted cruise vehicle speed error 328.

The weighted cruise vehicle speed error 328 is a desired acceleration used to adjust the vehicle acceleration to achieve the cruise vehicle speed set point 324. This weighted cruise vehicle speed error 328 is limited by a minimum acceleration 330 and a maximum acceleration 332. The maximum acceleration 332 is compensated by the road gradient compensation ratio 308 to provide a weighted maximum acceleration 334. The result of the weighted cruise vehicle speed error 328 limited by the minimum vehicle acceleration 330 and the weighted maximum vehicle acceleration 334 is the vehicle acceleration request 212.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic data tape storage, optical data tape storage, CDs, RAM devices, FLASH devices, MRAM devices and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers, or any other hardware components or devices, or a combination of hardware, software and firmware components.

Exemplary embodiments are described above. It, however, is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated.

While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle cruise control system comprising:
at least one controller programmed to, in response to a decrease in vehicle speed relative to a target cruise speed in an absence of driver acceleration demands, cause the vehicle to accelerate at a rate (i) less than or equal to a maximum that depends on road grade and the vehicle speed and (ii) that depends on the vehicle speed and a difference between the vehicle and target cruise speeds.

2. The system of claim 1, wherein the rate decreases as the road grade increases.

3. The system of claim 1, wherein the rate increases as the vehicle speed increases.

4. The system of claim 1, wherein the maximum increases as the vehicle speed increases.

5. The system of claim 1, wherein the maximum increases as the road grade increases.

6. A method of controlling vehicle speed comprising:
receiving a target cruise control speed and a cruise control operating mode;
selecting a speed control gain based on the cruise control operating mode and a difference between vehicle speed and the target cruise control speed;
generating a weighted speed error from the difference based on the speed control gain;
generating a road gradient compensation ratio based on the cruise control operating mode and a road gradient force representing a road grade; and
accelerating the vehicle at a rate based on the road gradient compensation ratio, the weighted speed error, and the vehicle speed such that the rate increases as the vehicle speed increases when the road grade is generally constant in an absence of driver acceleration demands and the rate decreases as the road grade increases in the absence of driver acceleration demands.

7. The method of claim 6, wherein the road gradient compensation ratio is further based on the vehicle speed and an estimated wheel torque.

8. The method of claim 6, wherein the rate is confined between maximum and minimum values and wherein the maximum and minimum values are based on the vehicle speed.

9. The method of claim 8, wherein the maximum is further based on the weighted speed error and the road gradient compensation ratio.

10. A method for controlling vehicle speed comprising:
in response to a decrease in vehicle speed relative to a target cruise control speed in an absence of driver acceleration demands, causing the vehicle to accelerate at a rate (i) less than or equal to a maximum that depends on vehicle speed and road grade, and (ii) that depends on the vehicle speed and a difference between the vehicle and target cruise control speeds such that the rate increases as the vehicle speed increases when the road grade is generally constant and the rate decreases as the road grade increases.

11. The method of claim 10, wherein the maximum increases as the vehicle speed increases.

12. The method of claim 10, wherein the maximum increases as the road grade increases.
